(19) United States
(12) Patent Application Publication
(10) Pub. No.: US 2008/0135643 A1
(43) Pub. Date: Jun. 12, 2008

(54) Pulsating spray dispensers

(75) Inventors: Jason C. Cohen, Appleton, WI (US); Corey Thomas Cunningham, Larsen, WI (US); David William Koenig, Menasha, WI (US)

Correspondence Address: KIMBERLY-CLARK WORLDWIDE, INC.;Catherine E. Wolf, 401 NORTH LAKE STREET, NEENAH, WI, 54956, US

(73) Assignee: Kimberly-Clark Worldwide, Inc.

(21) Appl. No.: 11/635,843

(22) Filed: Dec. 8, 2006

(51) Int. Cl. B05B 1/08

(52) U.S. Cl. 239/102.1

(57) ABSTRACT

A dispenser includes (i) a reservoir containing a personal care composition, wherein the personal care composition is a moisturizer, sun-protective material, after-sun care material, skin conditioning agent, astringent material, skin cleanser, acne treatment, cosmetic remover, massage oil, or skin nutrient agent; (ii) at least one nozzle in fluid communication with the reservoir; and (iii) an on-off frequency generator in fluid communication between the reservoir and the nozzle, the frequency generator adapted to deliver a pulse rate frequency of 0.1 to 500 Hz.

### BACKGROUND OF THE INVENTION

The present invention relates to dispensers and methods for delivering personal care compositions to the skin of a recipient. More specifically, the present invention relates to dispensers adapted to deliver personal care compositions to the skin of a recipient as a pulsating spray having a frequency and/or force selected to elicit a desired response in the recipient.

Conventional personal care compositions are often liquid, viscous, or semi-solid products in the form of lotions, creams, rinses, or washes. Many of these personal care compositions are designed to be dispensed into the hand of the user and to be applied by massaging or rubbing with the hands. Other personal care compositions are delivered to the skin via aerosol sprays and/or pump spray dispensers. For example, some sunscreens, deodorants, and the like are designed to be sprayed directly onto the skin. However, these prior art spray dispensers have provided personal care compositions as an essentially continuous spray of particles not as a pulsed application.

Other dispensers in the prior art have been adapted to deliver pulsating water to the body to wash various parts of the body. For example, hand washers, fingernail washers, nasal irritants, dental cleaners, and the like have provided pulsating bursts of water to clean hands, fingernails, nasal passages, teeth, and the like. However, these prior art pulse spray dispensers are adapted to physically remove dirt, oil, food, and other debris from the body with pulsating water delivered with relatively high force, not dispense personal care compositions to the skin.

Therefore, despite these known methods and apparatus, there remains a need for dispensers and methods adapted to deliver a personal care composition to the skin of a recipient as a pulsating spray having a frequency and/or force selected to elicit a desired response in the recipient.

### SUMMARY OF THE INVENTION

In response to this need, in one aspect, the present invention provides a dispenser. The dispenser includes a reservoir, a nozzle, and an on-off frequency generator. The reservoir includes a personal care composition, wherein the personal care composition is a moisturizer, sun-protective material, after-sun care material, skin conditioning agent, astringent material, skin cleanser, acne treatment, cosmetic remover, massage oil, or skin nutrient agent. The nozzle is in fluid communication with the reservoir. The on-off frequency generator is in fluid communication between the reservoir and the nozzle and the frequency generator is adapted to deliver a pulse rate frequency of 0.1 to 500 hertz (Hz).

In some embodiments, the dispenser may be adapted to deliver the personal care composition as particulates having a mean largest dimension of at least 10 micrometers (μm). In some embodiments, the personal care composition may have a viscosity of at least 50 centipoise (cps). In some embodiments, the frequency generator may be adapted to deliver a pulse rate frequency of 100 to 300 Hz. In some embodiments, the dispenser may be adapted to deliver the personal care composition at a mean force per particle of 0.053 to 1 milli Newton (mN).

In some embodiments, the personal care composition may be a moisturizing lotion and the frequency generator may be adapted to deliver a pulse rate frequency of 40 to 300 Hz and the dispenser is adapted to deliver the moisturizing lotion at a mean force per particle of 0.053 to 1 mN or at a mean force per particle of 1 to 500 mN.

In some embodiments, the personal care composition may be a sun-protective material and the frequency generator may be adapted to deliver a pulse rate frequency of 0.1 to 40 Hz and in some embodiments, the dispenser may be adapted to deliver the sun-protective material at a mean force per particle of 5 to 500 mN.

In some embodiments, the nozzle may include at least one orifice having an orifice diameter and the dispenser may include an orifice size controller.

Another aspect of the present invention provides a dispenser which includes (i) a reservoir containing a personal care composition; (ii) at least one nozzle in fluid communication with the reservoir; (iii) an on-off frequency generator in fluid communication between the reservoir and the nozzle; and (iv) a pulse rate controller adapted to transition the frequency generator from a first pulse rate frequency to a second pulse rate frequency and from the second pulse rate frequency to the first pulse rate frequency wherein the first pulse rate frequency is 0.1 to 35 Hz and the second pulse rate frequency is 35 to 500 Hz.

In some embodiments, the personal care composition may be an antiseptic solution.

Another aspect of the present invention provides a method of providing a system of dispensing a personal care composition. The method includes providing a dispenser which includes (i) a reservoir containing a personal care composition; (ii) at least one nozzle in fluid communication with the reservoir; (iii) an on-off frequency generator in fluid communication between the reservoir and the nozzle; and (iv) a pulse rate controller adapted to transition the frequency generator from a first pulse rate frequency to a second pulse rate frequency and from the second pulse rate frequency to the first pulse rate frequency wherein the first pulse rate frequency is 0.1 to 35 Hz and the second pulse rate frequency is 35 to 500 Hz. The method further includes providing instructions explaining how to transition the frequency generator between the first pulse rate frequency and the second pulse rate frequency. The method further includes enabling a user to dispense a personal care composition at two different frequencies.

In some embodiments, the method may further include providing instructions explaining the expected results of applying the personal care composition at the first pulse rate frequency and the expected results of applying the personal care composition at the second pulse rate frequency and enabling a user to select the desired results.

In some embodiments, the personal care composition may have a viscosity of at least 50 cps.

Another aspect of the present invention provides a dispenser including (i) a reservoir containing a personal care composition; (ii) at least one nozzle in fluid communication with the reservoir; (iii) an on-off frequency generator in fluid communication between the reservoir and the nozzle, the frequency generator adapted to deliver a pulse rate frequency of 20 to 500 Hz.

In some embodiments, the personal care composition may be an antiseptic solution and the frequency generator may be adapted to deliver a pulse rate frequency of 200 to 300 Hz. In some embodiments, the personal care composition may have a viscosity of at least 50 cps.

Another aspect of the present invention provides a dispenser including (i) at least one nozzle in fluid communication with an inlet; (ii) an on-off frequency generator in fluid communication between the inlet and the nozzle; (iii) a pulse rate controller adapted to transition the frequency generator over a pulse rate frequency of 20 to 500 Hz; and (iv) an attachment system adapted to establish fluid communication between the inlet of the dispenser and an outlet of a reservoir containing a personal care composition that is a moisturizer, sun-protective material, after-sun care material, skin conditioning agent, insect repellent, astringent material, skin cleanser, acne treatment, cosmetic remover, massage oil, or skin nutrient agent.

In some aspects the present invention provides a method of dispensing a personal care composition including 1) providing a dispenser including (i) at least one nozzle in fluid communication with an inlet; (ii) an on-off frequency generator in fluid communication between the inlet and the nozzle; (iii) a pulse rate controller adapted to transition the frequency generator over a pulse rate frequency of 20 to 500 Hz; and (iv) an attachment system adapted to establish fluid communication between the inlet of the dispenser and an outlet of a reservoir containing a personal care composition that is a moisturizer, sun-protective material, after-sun care material, skin conditioning agent, insect repellent, astringent material, skin cleanser, acne treatment, cosmetic remover, massage oil, or skin nutrient agent; 2) providing a reservoir containing a personal care composition that is a moisturizer, sun-protective material, after-sun care material, skin conditioning agent, insect repellent, astringent material, skin cleanser, acne treatment, cosmetic remover, massage oil, or skin nutrient agent; 3) joining the dispenser and the reservoir in fluid communication; 4) activating the on-off frequency generator; and 5) directing the personal care composition as a pulsed spray onto a skin surface of a recipient.

In some aspects the present invention provides a kit for dispensing a personal care composition. The kit includes 1) a dispenser including (i) at least one nozzle in fluid communication with an inlet; (ii) an on-off frequency generator in fluid communication between the inlet and the nozzle; (iii) a pulse rate controller adapted to transition the frequency generator over a pulse rate frequency of 20 to 500 Hz; and (iv) an attachment system adapted to establish fluid communication between the inlet of the dispenser and an outlet of a reservoir containing a personal care composition that is a moisturizer, sun-protective material, after-sun care material, skin conditioning agent, insect repellent, astringent material, skin cleanser, acne treatment, cosmetic remover, massage oil, or skin nutrient agent; 2) a reservoir containing moisturizer, sun-protective material, after-sun care material, skin conditioning agent, insect repellent, astringent material, skin cleanser, acne treatment, cosmetic remover, massage oil, or skin nutrient agent; and 3) instructions describing the joining of the dispenser and the reservoir in fluid communication and describing the activation of the frequency generator to deliver the personal care composition from the reservoir to a skin surface of a recipient as a pulsed spray.

### BRIEF DESCRIPTION OF THE DRAWINGS

FIG. 1 representatively illustrates the relative sensitivities of the four channels of mechano-reception as a function of frequency and displacement as adapted from Bolanowski et al.

FIG. 2 representatively illustrates the relative sensitivities of the four channels of mechano-reception as a function of frequency and force as adapted from Bolanowski et al. and Biggs et al.

FIG. 3 representatively illustrates an exemplary dispenser.

### DETAILED DESCRIPTION OF THE INVENTION

The present invention provides dispensers for delivering personal care compositions to the skin of a recipient as a pulsating spray having frequencies and/or forces selected to elicit specific responses in the recipient. While not wishing to be bound by theory, the present invention is believed to exploit the mechano-receptive response of the skin to various stimuli as described in the article entitled “Four Channels Mediate the Mechanical Aspects of Touch” by S. J. Bolanowski, Jr. et al. published in The Journal of the Acoustical Society of America, vol. 84, No. 5, November 1988, which is incorporated herein by reference where not contradictory.

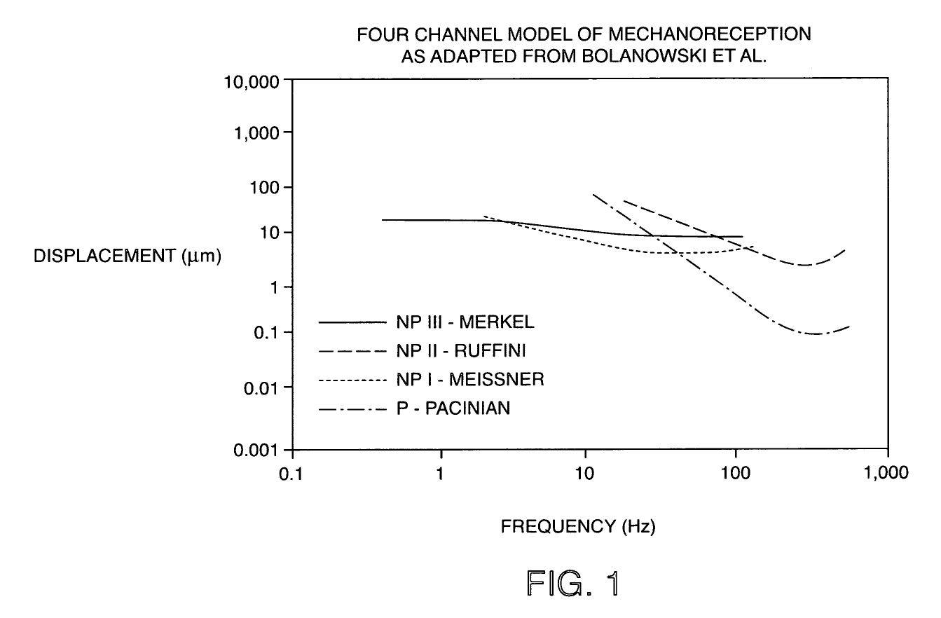

Bolanowski et al. describes four channels of mechano-receptive sensation that result in the perception of touch when one or more of the channels are activated. FIG. 1 illustrates the relative sensitivities of the four channels as a function of frequency and displacement and is adapted from the teachings of Bolanowski et al. The four channels are referred to in the art as NP I, NP II, NP III, and P and are associated with the anatomical mechano-receptors referred to as Meissner, Ruffini, Merkel, and Pacinian Corpuscle, respectively.

The forces required to displace the skin are summarized in a paper by James Biggs and Mandayam A. Srinivasan entitled “Tangential versus is Normal Displacements of Skin: Relative Effectiveness for Producing Tactile Sensations” which was published in the Symposium on Haptic Interfaces for Virtual Environment and Teleoperator Systems 2002: 121-128 (ISBN: 0-7695-1489-8). The symposium was held on Mar. 24-25, 2002 in Orlando, Fla., USA. This paper is incorporated herein by reference where not contradictory.

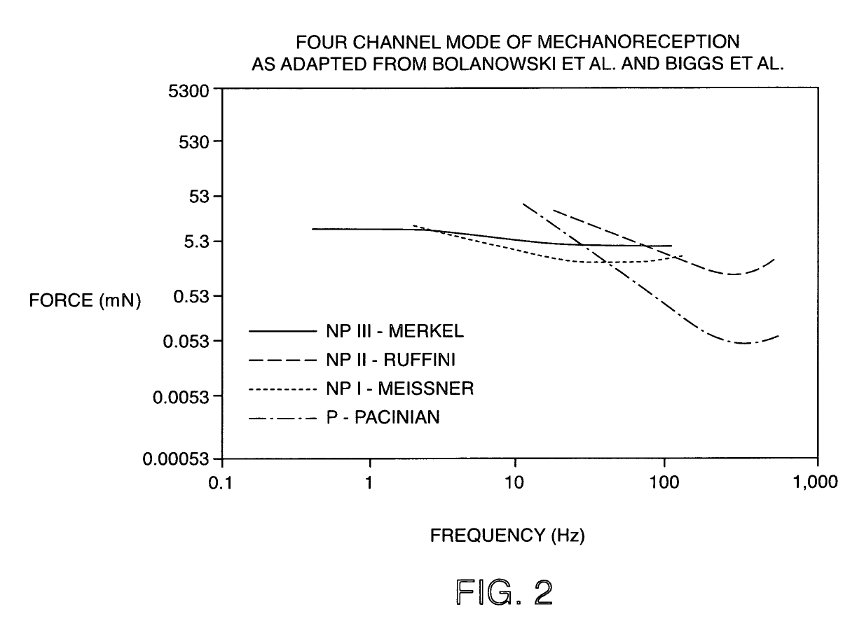

Biggs et al. investigated the normal and tangential forces of the skin during displacements. Using a measurement probe having a surface area of 0.785 mm², it was determined that 0.53 mN of force was required per μm of displacement (0.00053 N/μm). Using this ratio, the y-axis of FIG. 1 was converted from displacement (in μm) to force (in mN) which resulted in FIG. 2. In other words, FIG. 2 is an adaptation of Bolanowski et al. and Biggs et al. and representatively illustrates the relative sensitivities of the four channels as a function of force and frequency.

Based on the collective teachings of Bolanowski et al. and Biggs et al., it is believed that dispensers and methods may be adapted to deliver personal care compositions to the skin as a pulsating spray at frequencies and/or forces selected to activate one or more mechano-receptors and consequently elicit a specific response in the recipient of the personal care composition.

Referring to FIG. 2, the force required for detection is about 5 mN over the frequency range of 0.1 to about 40 Hz. However, at about 40 Hz the mechano-receptor identified as the “Pacinian Corpuscle” is activated before the others at a decreasingly lower force until about 250 Hz at which point the force required to activate the mechano-receptor starts to increase. Therefore, it is evident from FIG. 2 that the skin is most sensitive at about 250 Hz and requires only about 0.05 mN of force for detection. As such, a personal care composition applied to the skin at a pulsating frequency of about 250 Hz would be expected to be detected even at very low forces. This combination of force and frequency may allow for a very small amount of a personal care composition to be applied and yet still be detected by the user. This may be useful for applying very expensive compositions wherein the recipient would be expected to detect very small amounts and would potentially waste less. For example, it may be desirable to apply only small amounts of some perfumes, skin treatments, and anti-aging compositions that require very little quantity to be effective and are relatively expensive.

The relationship between force, frequency, and mechano-reception is illustrated in FIG. 2 and may be leveraged in other applications as well. For example, some personal care compositions may be applied at a frequency of about 0.1 to about 40 Hz and a mean force per particle of less than about 5.3 mN. This combination of force and frequency is at or below the threshold of mechano-detection (“subthreshold”) and is believed to be useful for applying personal care compositions to preexisting wounds, diaper rash, acne, or other sensitive skin conditions. Because, the application is at or below threshold, the recipient is expected to have little or no mechano-receptive perception which would be expected to result in less pain and/or discomfort proximate the affected wound or sensitive skin condition.

This same combination of force and frequency may also be suitable for application of personal care compositions to children. It is believed that many spray applications result in a “startle response” in children who may then resist further application. However, applying the personal care composition at forces and frequencies that are at or below threshold, may reduce/eliminate the mechano-receptive perception and thereby reduce the startle response allowing proper application of the personal care composition to the recipient.

In some applications, the “touch gate” phenomena may be triggered through select combinations of force and frequency. The touch gate phenomenon occurs when pain and touch occur at the same time. The pain can be lessened by the activation of the touch receptors. For example, when people bump some portion of their body, a natural instinct is to rub the affected area to sooth the pain. This phenomena may be recreated in the application of a personal care composition by pulsating at a frequency of about 40 to about 500 Hz and a mean force per particle of about 50 to 1000 mN. Application at these forces and frequencies are expected to activate multiple mechano-receptors which are believed to inhibit the perception of pain because the mechano-receptive response essentially overwhelms the pain response (nociceptive response). Application in these ranges may be useful for applying personal care compositions to sore, wounded, or sensitive skin.

A refreshing response may also be elicited in the recipient by applying a personal care composition at pulsating frequency of about 40 to about 500 Hz and a mean force per particle of about 50 to 1000 mN. It is believed that application in these ranges would trigger all four channels of mechano-reception and would provoke an invigorating response in the recipient.

Selecting frequencies and forces above threshold but at lower frequencies is also believed to be useful in some applications. For example, delivery of sunscreens, lotions, antiseptics, and the like may be useful at a frequency of about 0.1 to about 40 Hz and a mean force per particle of about 5.3 to about 500 mN. At these ranges, it is believed that the NP I and NP III channels of mechano-reception are triggered and the recipient will be able to detect the composition but not as strongly as with a traditional application. Therefore, it is believed that a user will apply more of the personal care composition to achieve the same perception they have come to expect from traditional applicators.

The methods and dispensers of the present invention are adapted to provide at least one personal care composition topically to the skin of a recipient. Some of the personal care compositions are also adapted such that at least a portion of the personal care composition remains on the skin of the recipient after application, i.e., “leave-on products.” Suitable personal care compositions include: moisturizers, occlusive materials, sun-protective materials, after-sun care materials, skin conditioning agents, skin coloring agents, antibacterial or antifungal materials, insect repellents, astringent materials, skin cleansers, acne treatment, make-up or other cosmetic removers, massage oils, skin nutrients and healing agents, spot and skin blemish treatment materials, skin whiteners and agents for treating pigmentation disorders, antiseptics and disinfectants, anti-aging agents, agents for treating sensitive skin, antiperspirants, deodorants, perfumes, and the like, and combinations thereof.

The personal care compositions of the present invention may be provided at any suitable viscosity that allows for pulsating spray applications. In some embodiments, the viscosity may be at least 10, 25, 50, 100, 250, 500, 1000, or 5000 cps. For example, some lotions may have a viscosity of about 8,000 to about 65,000 cps and some sprayable sunscreens may have a viscosity of about 5,000 cps.

The dispensers and methods of the present invention may be adapted to deliver the personal care compositions at any suitable particulate size to generate the proper force and thereby elicit the desired sensory effect on the skin of the recipient. In general, the dispensers and methods are adapted to deliver particulates having any suitable size. In some embodiments, the particulates have a mean largest dimension of greater than about 10 μm. In general, the dispensers and methods of the present invention do not “atomize” the personal care compositions.

The particle sizes, particle velocities, and particle patterns can be determined with a high speed camera and a laser emitting very short light pulses such as the VisiSizer Particle Droplet Image Analysis system available from Oxford Lasers Imaging Division having offices in Shirley, Mass., USA.

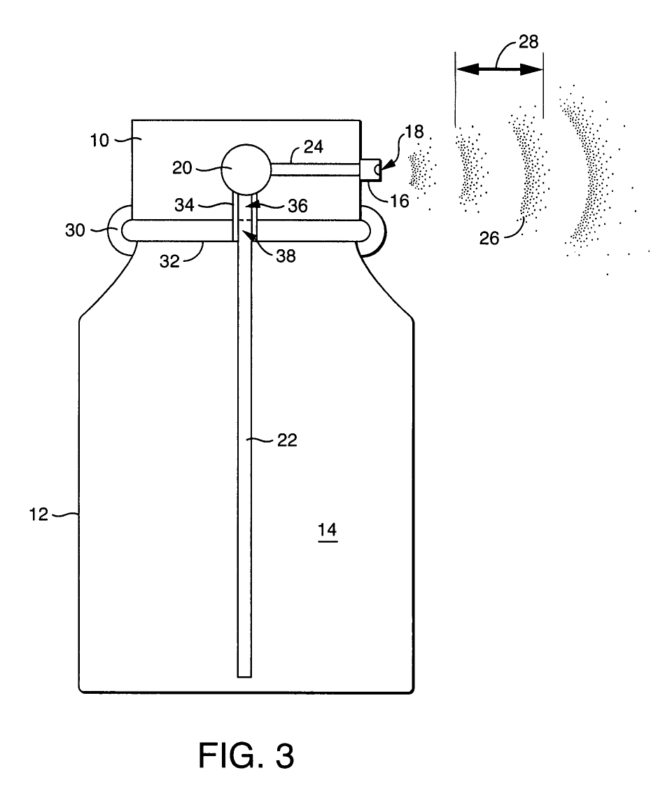

The personal care compositions may be delivered by any suitable dispenser having any suitable frequency generator capable of providing the pulsed spray at the requisite frequency. For example, FIG. 3 illustrates a cross-sectional view of an exemplary dispenser 10 and reservoir 12. The reservoir 12 is illustrated as containing at least one personal care composition 14 therein.

The reservoir 12 may be any suitable shape or size for containing the personal care composition 14. For example, the reservoir 12 may be a bottle, can, tube, or the like. The reservoir 12 may be made of any suitable material such as, for example, plastic, glass, metal, rubber, neoprene, or the like. In some embodiments, the reservoir 12 may be made from aluminum, high density polyethylene, polyester, low density polyethylene, polypropylene, polyvinylchloride, and the like, and combinations thereof.

In various embodiments, a reservoir may be provided with or without a personal care composition located therein. In embodiments wherein a reservoir is provided without a personal care composition, the reservoir may be adapted to receive a personal care composition added by the user.

In some embodiments, the dispenser may be provided without a reservoir and the dispenser may be adapted to deliver personal care compositions provided separately. In some embodiments, the dispensers may further include instructions describing how to fill the reservoirs with a personal care composition and/or how to attach the dispenser to a separate reservoir containing a personal care composition.

In some embodiments, the present invention may provide a method for delivering a personal care composition to the skin. The method may include providing a dispenser having a frequency generator wherein the dispenser is adapted to join in fluid connection with a reservoir. The method may further include providing a reservoir either with or without personal care compositions located therein. The method may further include providing instructions to a user or caregiver describing the operation of the dispenser and/or describing the expected responses.

Referring again to FIG. 3, in some embodiments, the dispenser may further include a nozzle 16, which may be made of any suitable material such as, for example, plastic, polymer, or the like. The nozzle 16 may include one or more orifices 18 adapted to provide an exit for the personal care composition 14 delivered from the dispenser. In various embodiments, the orifices 18 may have any suitable diameter or shape for delivering the desired particle size at the desired force.

In various embodiments, the nozzle, pulsed frequency generator, and/or reservoir may be in fluid communication by means of one or more conduits. For example, as illustrated in FIG. 3, the pulsed frequency generator 20 may be located in fluid communication between the reservoir 12 and the nozzle 16 via conduits 22 and 24.

In embodiments wherein the dispenser 10 and the reservoir 12 are provided separately, the dispenser 10 and the reservoir 12 may include any suitable attachment system for establishing fluid communication between the dispenser and the reservoir. For example, as illustrated in FIG. 3, the dispenser 10 may include a dispenser collar 30 and the reservoir 12 may include a reservoir collar 32. The dispenser collar 30 may be adapted to snap onto the reservoir collar 32 to attach the dispenser and the reservoir together. Additionally, the conduits 22 and/or 24 may include any suitable means for establishing fluid communication therebetween. In some embodiments, the dispenser may include an inlet adapted to receive a personal care composition and the reservoir may include an outlet adapted to discharge the personal care composition. In various embodiments, the inlet and the outlet may be joined in fluid communication by any suitable method. For example, as illustrated in FIG. 3, a coupler 34 may be utilized for establishing fluid communication between an inlet 36 of the dispenser 10 and an outlet 38 of the reservoir 12.

In some embodiments, the method may further include providing instructions describing how the dispenser and the reservoir are joined in fluid communication. In some embodiments, the dispensers and/or reservoirs may be sized such that an average adult may hold them in the hand and activate the dispenser.

The pulsed frequency generator 20 may be any suitable mechanism adapted to deliver the personal care composition 14 from the dispenser 10 in a pulsed spray 26 having a pulsation frequency 28. Specifically, the pulsed frequency generator may be any suitable mechanism capable of cycling at a frequency of 0.1 to 1000 Hz and thereby delivering the personal care composition as a pulsed spray having a pulsation frequency of 0.1 to 1000 Hz. In various embodiments, the pulsed frequency generator may be adapted to cycle at 0.1 to 500 Hz and deliver the personal care composition at a pulsation frequency of 0.1 to 500 Hz. In some embodiments, the frequency generator may be adapted to cycle at least at 0.1, at least at 20, at least at 35, or at least at 40 Hz. In some embodiments, the frequency generator may be adapted to cycle at less than 1000, at less than 500, at less than 300, at less than 40, or at less than 35 Hz. All combinations of upper and lower limits are also contemplated.

As used herein, the term “pulsed frequency generator” or “on-off frequency generator” is used to describe mechanisms adapted to alternatively open (on) or close (off) thereby permitting or prohibiting the flow of the personal care composition from the dispenser at a pulsation frequency. In some embodiments, the on-off frequency generator may be driven by any suitable motive force sufficient to generate the desired pulse rate frequency. For example, in some embodiments, fluid pressure, direct current (e.g., battery power), or alternating current may drive the on-off frequency generator.

In various embodiments, the personal care composition may be transported by any suitable means to and/or past the frequency generator. For example, the personal care composition may be propelled from areas of higher pressure to areas of lower pressure by pressure forces. The pressure forces may be generated by any suitable means, such as, for example, gas or mechanical pressurization. Suitable gases include air; nitrogen; carbon dioxide; hydrocarbons such as ethane, propane, butane, and the like; chlorofluorocarbons such as Freon and the like; and combinations thereof. The pressure forces may be exerted directly on the personal care composition or may be exerted on an intermediate structure such as a bladder, diaphragm, or the like, which in turn exerts pressure on the personal care composition. In some embodiments, the personal care compositions may be moved by siphon forces such as those generated by a pump. In some embodiments, the personal care compositions may be moved by centripetal forces. In some embodiments, the personal care compositions may be physically propelled by any suitable mechanical device such as a propeller.

One suitable on-off frequency generator includes a butterfly valve. The butterfly valve may be adapted to oscillate at a given frequency and thereby alternatively block and release the personal care composition at the desired pulsed frequency.

Another suitable on-off frequency generator includes a spinner valve wherein two plates with at least one hole each are rotated in facing relationship. When the holes align, the personal care composition may exit past the frequency generator and to the nozzle. When the holes are not aligned, the flow of personal care composition is blocked thereby resulting in a pulsating spray. The number of holes in either or both discs may be changed to achieve the desired frequency. Additionally or alternatively, the speed by which either or both discs are rotated can be changed to achieve the desired frequency.

Another suitable on-off frequency generator includes solenoid valves that open and close at suitable rates. For example, INKA Series miniature solenoid valves used in conjunction with an appropriate high speed drive circuit are expected to deliver the required pulse rate frequencies and are available from The Lee Company having offices in Westbrook, Conn., USA. In embodiments utilizing one or more solenoids as the on-off frequency generator, the solenoid cycle speed can be controlled through a drive circuit as is known in the art.

In some embodiments, the frequency generator may include a roller pump having any suitable number of internal rollers. The rollers may be adapted to impart a pulsating effect in the delivery of the personal care composition. The roller pump can be driven at any suitable number of revolutions per minute. Each roller in the roller pump causes a pulse of personal care composition to be ejected from the pump. Thus the number of pulses per minute is equal to the revolutions per minute multiplied times the number of rollers. By adjusting the number of rollers and/or the number of revolutions per minute, the cycle frequency can be selected to be any suitable rate.

In some embodiments, the frequency generator may cycle at a fixed frequency to deliver the personal care composition from the dispenser at the fixed pulsation frequency. In other embodiments, the frequency generator may include a pulse rate control mechanism and may be manually adjustable by a user from a first pulse rate frequency to a second pulse rate frequency to deliver the personal care composition from the dispenser at the first pulsation frequency and the second pulsation frequency respectively. For example, in some embodiments, a pulse rate controller may be utilized to transition the frequency generator between the first pulsed frequency and the second pulsed frequency.

In another example, a pulse rate controller for a roller pump may increase or decrease the speed by which the pump rotates, thereby increasing or decreasing the cycles per second. In other embodiments, the pulse rate control mechanism for a butterfly valve may increase or decrease the speed at which the valve opens and closes. In yet other embodiments wherein the frequency generator is driven by the pressure of the personal care composition, the pulse rate control mechanism may include a drag control for increasing or decreasing the drag on the butterfly valve. For example, a personal care composition passing through a butterfly valve with a lower drag force applied will be delivered at a higher cycle rate than if the same personal care composition is passed through the same butterfly valve with a higher drag force applied.

The frequency by which the dispenser delivers the personal care composition can be determined by any suitable means. For example, high speed video may be used to capture images of the personal care composition spraying from the dispenser and the frequency of the pulses may be determined by counting the pulses passing a reference point in a fixed period of time. Alternatively, high speed video of the frequency generator may be utilized to count the open/close cycles within a given period of time to determine the frequency.

The mean force per particle by which the dispenser delivers the personal care composition can be determined by any suitable means. For example, high speed video may be used to capture images of the personal care composition spraying from the dispenser and the force can be calculated using the formula: Mean Force (F) per particle=mean particle mass (m) times mean particle acceleration (A).

The mean particle mass can be determined by measuring the mean particle volume and multiplying by the density of the personal care composition. It is believed that the mean particle volume can be accurately measured using a high speed camera and a laser emitting very short light pulses such as the VisiSizer Particle Droplet Image Analysis system available from Oxford Lasers Imaging Division having offices in Shirley, Mass., USA.

It is believed that the mean particle acceleration can be determined by measuring the mean particle velocity using the same high speed technique. Once the mean particle velocity is determined, the mean particle acceleration (A) can be determined by taking the integral of the mean particle velocity. The mean force per particle may then be calculated.

The mean force per particle can be controlled by any suitable means. For example, the mean force per particle can be adjusted by either changing the mean mass of the particles, changing the mean acceleration of the particles or both. The mass of the particles can be changed by changing the size of the particles. The particle size may be changed by changing the size and/or shape of the orifice through which the personal care composition passes. Therefore some embodiments may include one or more orifices wherein the diameter of the orifices can be manipulated by the user via an orifice size controller to manipulate the mean force per particle by which the personal care composition is delivered.

Other suitable means for controlling the force include changing the density of the personal care composition. All other parameters being equal, a denser personal care composition will be delivered with greater force than a less dense composition. In another example, the acceleration of the particles may be increased or decreased by increasing or decreasing the pressure within the reservoir containing the personal care composition. In general, the force by which the personal care composition is delivered may be preset during manufacturing or may be adjustable by the user by any suitable means.

In some embodiments, the dispenser may include a moisturizing lotion. The frequency generator may be adapted to deliver a pulse rate frequency of 40 to 300 Hz and the dispenser may be adapted to deliver the moisturizing lotion at a mean force per particle of at least 0.053 mN. In reference to FIG. 2, the force required to reach the threshold perception starts to decline at about 40 Hz reaching a low at about 250 Hz. Therefore, lotions may be applied with very low force in these frequency ranges and can still be detected. For example, at 250 Hz only about 0.053 mN of force is required to activate the P channel. To achieve forces this low, the particles are likely to have a lower mean particle size and/or have a lower mean velocity. At these ranges, it is believed that the recipient will apply less lotion because the user will perceive that an “adequate” or “normal” amount has been delivered to the skin wherein a lesser amount has actually been dispensed. This combination of parameters may be desirable for personal care compositions that are applied in relatively small amounts. For example, some personal care compositions may have high efficacy and therefore require less material to be effective. Some may be expensive and may be conserved by delivering a smaller amount while still providing a satisfying perception.

In some embodiments, the frequency generator may be adapted to deliver a lotion at a frequency of 40 to 300 Hz and the dispenser may be adapted to deliver the lotion at a mean force per particle of 1 to 500 mN. Again referring to FIG. 2, parameters in these ranges are expected to activate the NP I channel and/or the P channel at lower forces. At higher forces, three or four of the channels may be activated within these frequency ranges. Adapting a dispenser to operate in this range may be desirable to create the impression in the recipient that a “normal” amount of lotion is being applied when actually a lesser amount is being applied. In the case of lotions, a large amount of lotion may create a greasy feel, therefore adapting the dispenser as suggested may reduce the chances of over application and the resulting greasy feeling.

In some embodiments, the dispensers may include sun-protective material. It is generally believed that insufficient quantities of sun-protective materials are applied to the skin of recipients. As such, the recipient may not have the expected protection from the sun. In various embodiments of the present invention, a dispenser may be adapted to deliver the sunscreen at a mean force per particle of at least 5 mN and the frequency generator may be adapted to deliver a pulse rate frequency of 0.1 to 40 Hz. Again referring to FIG. 2, parameters within these ranges would be expected to activate the NP III channel and/or the NP I channel. Adapting a dispenser to operate in this range may be desirable to create the impression in the recipient that a “normal” amount of lotion is being applied when actually a larger amount is being applied.

In some embodiments, a dispenser may include a frequency generator that is adapted to produce a first pulse rate and at least one second pulse rate wherein the second pulse rate is different than the first. In some embodiments, the dispenser may be transitioned from the first pulse rate frequency to the second pulse rate frequency and from the second pulse rate frequency to the first pulse rate frequency. In some embodiments, the first pulse rate frequency is 0.1 to 35 Hz and the second pulse rate frequency is 35 to 500 Hz. As can be seen in FIG. 2, the sensitivity of touch is relatively flat up to about 35 Hz. At that frequency additional channels can be activated. Therefore, in some embodiments, it may be desirable for the user to select whether the personal care composition is delivered at the more sensitive frequencies or at the less sensitive frequencies. This may be desirable when a dispenser is used to deliver two different personal care compositions.

Some embodiments may include a method of providing a system of dispensing a personal care composition. The method may include providing any of the dispensers described herein. In particular, the method may include providing a dispenser having a frequency generator that is adapted to produce a first pulse rate frequency and at least one second pulse rate frequency wherein the second pulse rate frequency is different than the first. For example, the first pulse rate frequency may be 0.1 to 35 Hz and the second pulse rate frequency may be 35 to 500 Hz. The method may further include providing instructions to a user explaining how to transition the frequency generator between the first pulse rate frequency and the second pulse rate frequency thereby enabling the user to dispense a personal care composition at two different frequencies or a first personal care composition at a first frequency and a second personal care composition at a second frequency. In some embodiments, the method may further include providing instructions explaining the expected results of applying the personal care compositions at the first pulse rate frequency and the expected results of applying personal care compositions at the second pulse rate frequency thereby enabling the user to select the desired results.

For example, the instructions may explain that a personal care composition applied at lower frequencies, e.g., 1 Hz may be expected to feel like a little is being applied when actually a larger amount is being applied. These applications may be well suited for children who are less willing to have personal care compositions applied. As such, a “proper” amount may actually be applied wherein only a smaller amount is detected.

In some embodiments, the instructions may explain that a personal care composition applied at higher frequencies, e.g., 250 Hz, may be expected to be perceived as applying more than actually is being applied. These applications may be well suited for children to reduce waste of the product.

As discussed above, in some embodiments, dispensers may be provided without reservoirs. In these embodiments, the dispensers include at least one nozzle in fluid communication with an inlet. The dispensers further include an on-off frequency generator in fluid communication between the inlet and the nozzle. The frequency generator may be regulated with a pulse rate controller. The pulse rate controller may be adapted to transition the frequency generator over a pulse rate frequency of 20 to 500 Hz. The dispensers of these embodiments may also include an attachment system adapted to establish fluid communication between the inlet of the dispenser and an outlet of any suitable reservoir. The reservoirs may include personal care compositions or may be adapted to receive personal care compositions. For example, reservoirs containing a personal care composition such as a moisturizer, sun-protective material, after-sun care material, skin conditioning agent, insect repellent, astringent material, skin cleanser, acne treatment, cosmetic remover, massage oil, or skin nutrient agent may be provided.

A method of dispensing a personal care composition may include providing a dispenser as described above and also providing a reservoir containing a personal care composition that is a moisturizer, sun-protective material, after-sun care material, skin conditioning agent, insect repellent, astringent material, skin cleanser, acne treatment, cosmetic remover, massage oil, or skin nutrient agent. The method may further include joining the dispenser and the reservoir in fluid communication. Once joined together the on-off frequency generator may be activated to direct the personal care composition as a pulsed spray onto a skin surface of a recipient.

In some embodiments, the dispensers of the present invention may be provided as kits. For example, a kit for dispensing a personal care composition may include a dispenser without a reservoir attached wherein the dispenser includes at least one nozzle in fluid communication with an inlet and the dispenser further includes an on-off frequency generator in fluid communication between the inlet and the nozzle.

In various embodiments, the frequency generator may be regulated with a pulse rate controller. In some embodiments, kits may also include a reservoir containing any suitable personal care composition. For example, the reservoir may include moisturizer, sun-protective material, after-sun care material, skin conditioning agent, insect repellent, astringent material, skin cleanser, acne treatment, cosmetic remover, massage oil, or skin nutrient agent. In some embodiments, the kit may further include instructions describing how the dispenser is joined to the reservoir to establish fluid communication between the two. In some embodiments, the kit may also include instructions describing how to activate the frequency generator to deliver the personal care composition from the reservoir to a skin surface of a recipient as a pulsed spray.

While the invention has been described in detail with respect to specific embodiments thereof, it will be appreciated that those skilled in the art, upon attaining understanding of the foregoing will readily appreciate alterations to, variation of, and equivalents to these embodiments. Accordingly, the scope of the present invention should be assessed as that of the appended claims and any equivalents thereto.

1. A dispenser comprising,
(i) a reservoir containing a personal care composition, wherein the personal care composition is a moisturizer, sun-protective material, after-sun care material, skin conditioning agent, astringent material, skin cleanser, acne treatment, cosmetic remover, massage oil, or skin nutrient agent;
(ii) at least one nozzle in fluid communication with the reservoir; and
(iii) an on-off frequency generator in fluid communication between the reservoir and the nozzle, the frequency generator adapted to deliver a pulse rate frequency of 0.1 to 500 Hz.

2. The dispenser of claim 1 wherein the dispenser is adapted to deliver the personal care composition as particulates having a mean largest dimension of at least 10 μm.

3. The dispenser of claim 1 wherein the personal care composition has a viscosity of at least 50 cps.

4. The dispenser of claim 1 wherein the frequency generator is adapted to deliver a pulse rate frequency of 100 to 300 Hz.

5. The dispenser of claim 4 wherein the dispenser is adapted to deliver the personal care composition at a mean force per particle of 0.053 to 1 mN.

6. The dispenser of claim 3 wherein the personal care composition is a moisturizing lotion and the frequency generator is adapted to deliver a pulse rate frequency of 40 to 300 Hz and the dispenser is adapted to deliver the moisturizing lotion at a mean force per particle of 0.053 to 1 mN.

7. The dispenser of claim 6 wherein the dispenser is adapted to deliver the moisturizing lotion at a mean force per particle of 1 to 500 mN.

8. The dispenser of claim 1 wherein the personal care composition is a sun-protective material and the frequency generator is adapted to deliver a pulse rate frequency of 0.1 to 40 Hz and the dispenser is adapted to deliver the sun-protective material at a mean force per particle of 5 to 500 mN.

9. The dispenser of claim 1 wherein the nozzle includes at least one orifice having an orifice diameter and the dispenser includes an orifice size controller.

10. A dispenser comprising,
(i) a reservoir containing a personal care composition;
(ii) at least one nozzle in fluid communication with the reservoir;
(iii) an on-off frequency generator in fluid communication between the reservoir and the nozzle; and
(iv) a pulse rate controller adapted to transition the frequency generator from a first pulse rate frequency to a second pulse rate frequency and from a second pulse rate frequency to a first pulse rate frequency wherein the first pulse rate frequency is 0.1 to 35 Hz and the second pulse rate frequency is 35 to 500 Hz.

11. The dispenser of claim 10 wherein the personal care composition is an antiseptic solution.

12. A method of providing a system of dispensing a personal care composition comprising,
providing the dispenser of claim 10;
providing instructions explaining how to transition the frequency generator between the first pulse rate frequency and the second pulse rate frequency; and
enabling a user to dispense a personal care composition at the first pulse rate frequency or the second pulse rate frequency.

13. The method of claim 12 further comprising,
providing instructions explaining the expected results of applying the personal care composition at the first pulse rate frequency and the expected results of applying the personal care composition at the second pulse rate frequency and
enabling a user to select the desired results.

14. The dispenser of claim 10 wherein the personal care composition has a viscosity of at least 50 cps.

15. A dispenser comprising,
(i) a reservoir containing a personal care composition;
(ii) at least one nozzle in fluid communication with the reservoir; and
(iii) an on-off frequency generator in fluid communication between the reservoir and the nozzle, the frequency generator adapted to deliver a pulse rate frequency of 20 to 500 Hz.

16. The dispenser of claim 15 wherein the personal care composition is an antiseptic solution and the frequency generator is adapted to deliver a pulse rate frequency of 200 to 300 Hz.

17. The dispenser of claim 15 wherein the personal care composition has a viscosity of at least 50 cps.

18. A dispenser comprising,
(i) at least one nozzle in fluid communication with an inlet;
(ii) an on-off frequency generator in fluid communication between the inlet and the nozzle;
(iii) a pulse rate controller adapted to transition the frequency generator over a pulse rate frequency of 20 to 500 Hz; and
(iv) an attachment system adapted to establish fluid communication between the inlet of the dispenser and an outlet of a reservoir containing a personal care composition that is a moisturizer, sun-protective material, after-sun care material, skin conditioning agent, insect repellent, astringent material, skin cleanser, acne treatment, cosmetic remover, massage oil, or skin nutrient agent.

19. A method of dispensing a personal care composition, comprising,
providing the dispenser of claim 18;
providing a reservoir containing a personal care composition that is a moisturizer, sun-protective material, after-sun care material, skin conditioning agent, insect repellent, astringent material, skin cleanser, acne treatment, cosmetic remover, massage oil, or skin nutrient agent;
joining the dispenser and the reservoir in fluid communication;
activating the on-off frequency generator; and
directing the personal care composition as a pulsed spray onto a skin surface of a recipient.

20. A kit for dispensing a personal care composition, comprising,
the dispenser of claim 18;
a reservoir containing moisturizer, sun-protective material, after-sun care material, skin conditioning agent, insect repellent, astringent material, skin cleanser, acne treatment, cosmetic remover, massage oil, or skin nutrient agent; and
instructions describing the joining of the dispenser and the reservoir in fluid communication and describing the activation of the frequency generator to deliver the personal care composition from the reservoir to a skin surface of a recipient as a pulsed spray.
